(19) United States
(12) Patent Application Publication
(10) Pub. No.: US 2010/0116104 A1
(43) Pub. Date: May 13, 2010

(54) Screw Driver With A Variable Handle

(76) Inventor: Kun-Chih Hung, Ta-Li (TW)

Correspondence Address: Wang Law Firm, Inc., 4989 Peachtree Parkway,, Suite 200, Norcross, GA, 30092, US

(21) Appl. No.: 12/268,393

(22) Filed: Nov. 10, 2008

(51) Int. Cl. B25G 1/08

(52) U.S. Cl. 81/490

(57) ABSTRACT

A screw driver with a variable handle has a body. One end of the body has a mounting part, and the other end is pivotally installed with an auxiliary handle. The body has an accommodating room for accommodating an accommodating box. The auxiliary handle covers the accommodating room when storing the screw driver. It is flipped open for holding when the screw driver is in use.

### BACKGROUND OF THE INVENTION

1. Field of Invention

The invention relates to a screw driver with a variable handle and, in particular, to a screw driver with a collapsible auxiliary handle.

2. Related Art

The conventional screw driver is usually a simple straight bar with a working head on its one end. The rod has a handle for the user to hold and turn, with the working head driving an object such as a screw. However, one usually has to impose a larger torque when fastening or loosening a screw. Such a straight-bar screw driver is difficult to use in such situations because the driving direction of the working head is the same as that of the straight bar.

FIG. 6 shows a conventional Allen wrench, which is different from the usual screw driver. As shown in the drawing, it has a straight bar 90 with a working head 91 on its one end. The other end is mounted with a handle 92 to render a T shape. Therefore, the user can hold the T-shaped handle 92 to easily exert a torque.

However, even though such an Allen wrench is easier for the user to impose a force, it occupies more space due to its T-shaped handle 92. Therefore, it is inconvenient in carrying and storage.

Besides, current screw drivers or wrenches have various kinds of working heads 91. Therefore, the working heads 91 are made removable. In general, the screw driver has an accommodating space to accommodate the replaceable working heads. A blocking element (such as a dial or cover) blocks the outlet of the working heads. The problem with this kind of screw drivers is that the working heads often slip out.

The invention is thus set to solve the above-mentioned problems of screw drivers.

### SUMMARY OF THE INVENTION

An objective of the invention is to provide a screw driver with a variable handle that helps imposing a torque when in use and is easy for storage as well.

Another objective of the invention is to ensure that the working heads stored in the screw driver do not fall out when it is in use.

To achieve the above-mentioned objectives, the invention includes: a body and an accommodating box.

The body has an accommodating room between its two ends. One end of the body is provided with a mounting part for a working head to mount thereon. The other end is pivotally disposed with an auxiliary handle that covers the accommodating room. Moreover, at least a friction ring is disposed between the body and the auxiliary handle so that it becomes a little tight when the two pivotally rotate.

The accommodating box is inside the accommodating room. Its one end is pivotally connected with the body. Its other end has an opening for inserting working heads therein. The opening faces the wall of the accommodating room. At least one protruding part is formed on the sidewall of the accommodating room in order to slightly urge the accommodating box.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the disclosed screw driver;

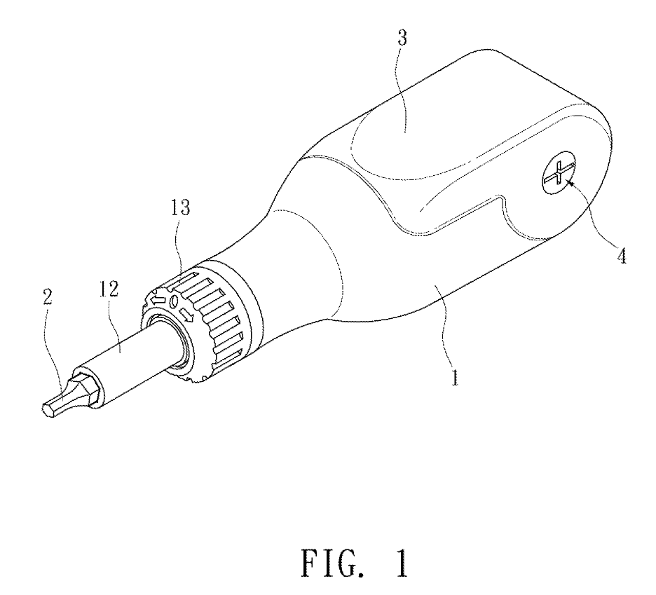

FIG. 2 is a schematic view of the screw driver when the auxiliary handle and the accommodating box are opened;

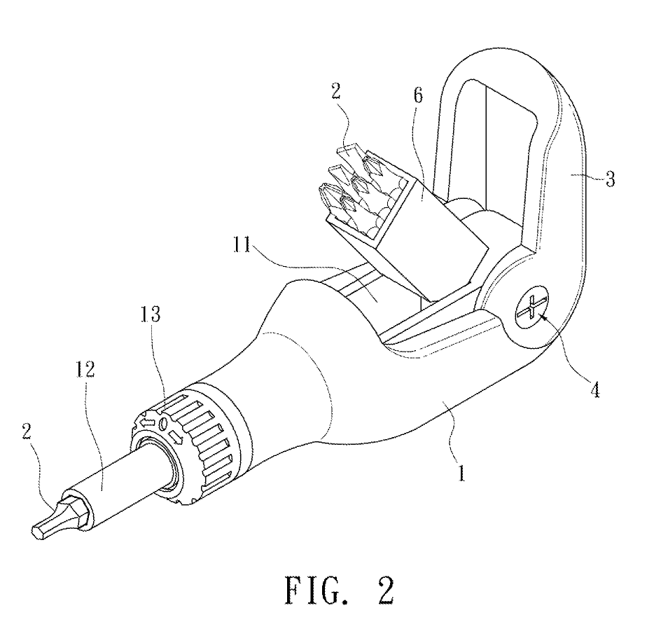

FIG. 3 is a three-dimensional exploded view of the disclosed screw driver;

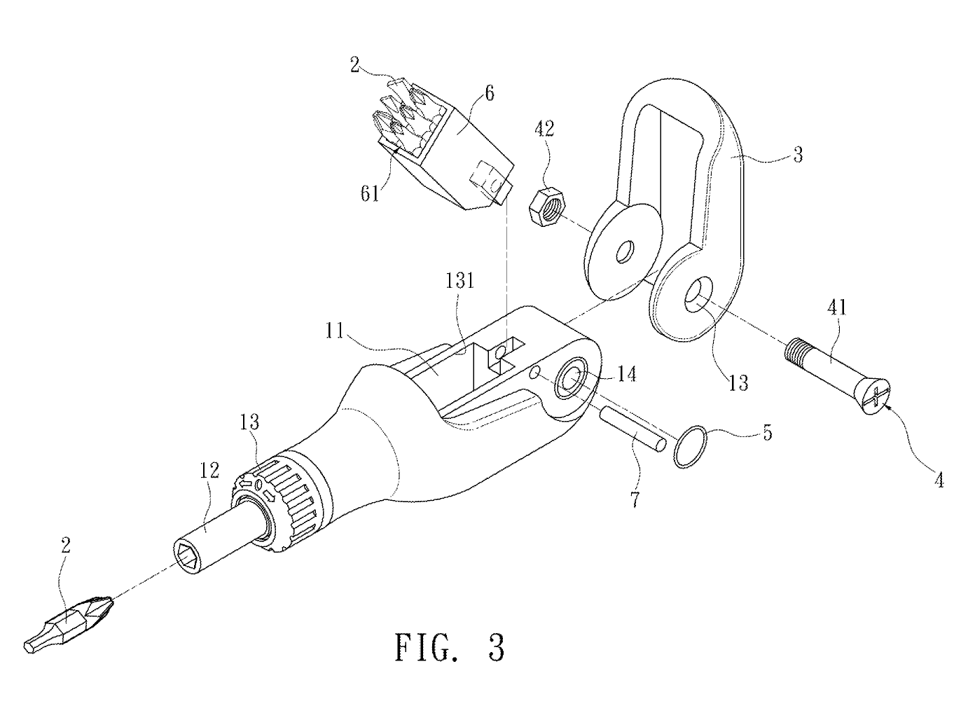

FIG. 4 is a cross-sectional view showing how the auxiliary handle and the accommodating box are pivotally installed in the body;

FIG. 5 is a schematic view of the disclosed screw driver in use; and

FIG. 6 is a three-dimensional view of the conventional screw driver.

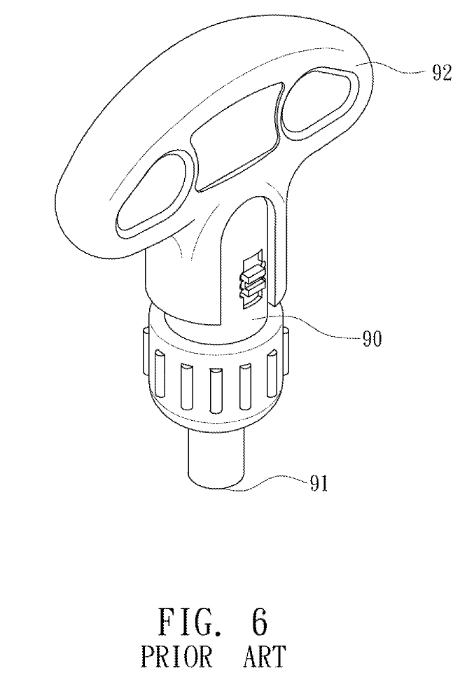

### DETAILED DESCRIPTION OF THE INVENTION

The present invention will be apparent from the following detailed description, which proceeds with reference to the accompanying drawings, wherein the same references relate to the same elements.

An embodiment of the disclosed screw driver with a variable handle includes: a body 1, at least one friction ring 5, and an accommodating box 6.

The body 1 has an accommodating room 11 between its two ends. One end of the body 1 is provided with a mounting part 12 for a working head 2 to mount thereon. In this embodiment, a ratchet mechanism 13 is installed between the mounting part 12 and the body 1.

The other end of the body 1 is pivotally installed with an auxiliary handle 3 to cover the accommodating room 11. In this embodiment, the body 1 has two first through holes 14 on the end of the auxiliary handle 3. The auxiliary handle 3 has a second through hole 31 on the end corresponding to the body 1. The second through hole 31 and the two first through holes 14 are inserted with an insertion element 4 to position the body 1 and the auxiliary handle 3. In this embodiment, the insertion element 4 includes a screw 41 going through the through holes 14, 31 and a bolt 42 that matches with the screw 41.

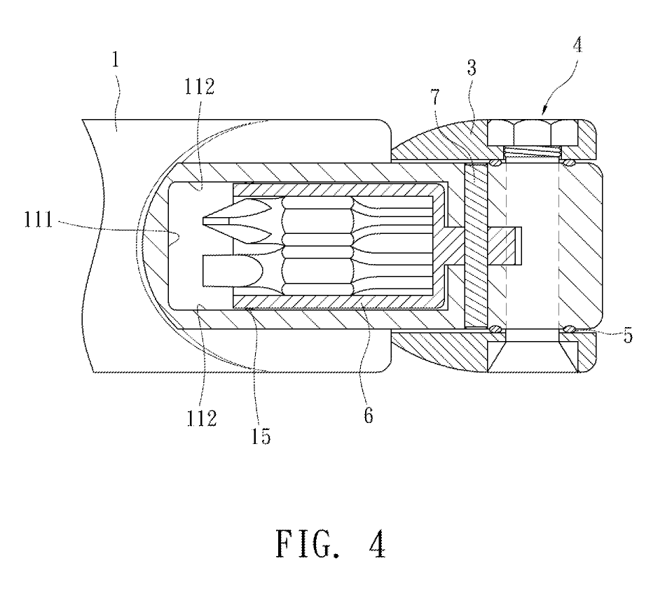

The friction ring 5 is sandwiched between the pivotally connected body 1 and auxiliary handle 3, so that it is a little tight when they rotate with respect to each other (FIG. 4).

The accommodating box 6 is inside the accommodating room 11. One end of the accommodating box 6 is pivotally connected with the body 1. The other end has an opening 61 facing the wall 111 in the accommodating room 11. Working heads 2 are inserted via the opening 61 into the accommodating box 6. In this embodiment, the accommodating box 6 is pivotally mounted on the body 1 with the end facing the auxiliary handle 3 using a pin 7.

At least one protruding part 15 is provided on the sidewall 112 of the accommodating room 11 (FIG. 4). When the accommodating box 6 is disposed in the accommodating room 11, the protruding part 15 slightly urges the accommodating box 6 in the accommodating room 11. In this embodiment, the body 1 has two protruding parts 15 near the opening 113 on the sidewall 112 of the accommodating room 11.

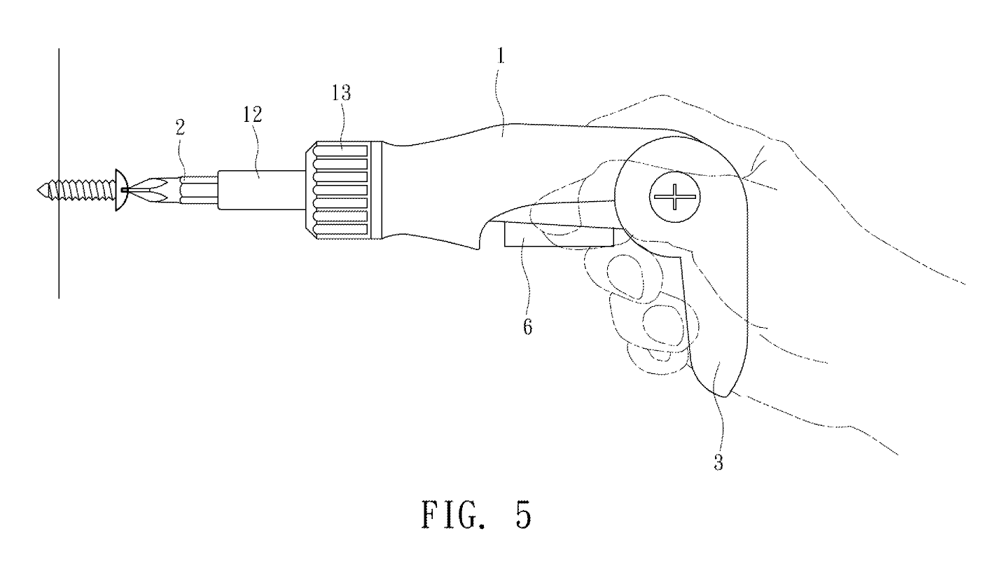

When the disclosed screw driver is in use, the user can either close the auxiliary handle 3 and turn or open it and turn. In practice, at the beginning or turning a screw, one does not need to impose a large torque. Therefore, the user can close the auxiliary handle 3 and turn. Once the screw is fastened to some extent, the user can open the auxiliary handle 3 (as shown in FIG. 5, the angle between the auxiliary handle 3 and the body 1 being adjusted according to need). In this case, the user can hold the auxiliary handle and the body 1 in order to exert a larger torque on the screw.

The body 1 has an accommodating room 11. The accommodating box 6 in the accommodating room 11 allows the user's finger to urge when the user holds the screw driver. Therefore, the fingers do not urge against the accommodating room 11 and cause any inconvenience. The accommodating box 6 in this embodiment is rectangular. It of course can have some other shape.

The opening 61 of the accommodating box 6 faces the wall 111 of the accommodating room 11. It can be flipped with respect to the body and positioned in or outside the accommodating room 11. Therefore, to replace the working head 2, one simply pivotally opens the accommodating box 6 and takes out the desired working head 2. After the replacement, the accommodating box 6 is disposed back into the accommodating room 11. Since the opening 61 faces the wall 111, the working heads 2 are blocked by the wall 111 and stay inside the accommodating box 6 even when the screw driver is in use. Besides, when the accommodating box 6 is disposed in the accommodating room 11 of the body 1, it is urged by the protruding parts 15 and positioned in the accommodating room 11. Therefore, working heads 2 in the accommodating box 6 will not fall off.

It should be mentioned that the working heads 2 in the accommodating box 6 can have working heads 2 on both ends, so that there are more driving choices.

It is seen in the above description that the primary advantage of the invention is the additional torque with the help of the auxiliary handle 3 pivotally installed on one end of the body 1. When not in use, the auxiliary handle 3 can be accommodated in the accommodating room 11 for the convenience of storage.

Since the working heads 2 are accommodated in the accommodating box 6 in the accommodating room 11, the space inside the body 1 is fully utilized. Moreover, the opening 61 faces the wall 111 so that they do not easily fall off. Therefore, when the user turns the screw driver, the working heads 2 are firmly positioned inside the accommodating box 6 without affecting the work.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A screw driver with a variable handle, comprising:
a body, which has an accommodating room between its two ends, with one end provided with a mounting part for a working head to mount thereon and the other end pivotally installed with an auxiliary handle that covers the accommodating room, wherein a friction ring is disposed between the body and the auxiliary handle to make it a little tight for them to rotate respect with each other; and
an accommodating box, which is in the accommodating room with one end pivotally connected with the body and the other end having an opening for the insertion of the working heads, the opening facing the wall of the accommodating room, wherein at least one protruding part is formed on the sidewall of the accommodating room to urge against the accommodating box.

2. The screw driver with a variable handle of claim 1, wherein one end of the auxiliary handle has at least one first through hole and the corresponding end of the auxiliary handle has a second through hole matching with the first through hole, and an insertion element goes through the first through hole and the second through hole to position the body and the auxiliary handle.

3. The screw driver with a variable handle of claim 2, wherein the insertion element includes a screw going through the through holes and a bolt that matches with the screw.

4. The screw driver with a variable handle of claim 1, wherein the accommodating box is pivotally installed on the body by the end facing the auxiliary handle using a pin.

5. The screw driver with a variable handle of claim 1, wherein two protruding parts are formed on the sidewall of the accommodating room near the opening.
